(19) United States
(12) Patent Application Publication
(10) Pub. No.: US 2008/0042962 A1
(43) Pub. Date: Feb. 21, 2008

(54) DISPLAY AND DISPLAY PANEL THEREOF

(75) Inventor: Meng-Yi Hung, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: AU OPTRONICS CORPORATION, Hsinchu (TW)

(21) Appl. No.: 11/611,146

(22) Filed: Dec. 15, 2006

(30) Foreign Application Priority Data
Aug. 21, 2006 (TW) 95130614

(51) Int. Cl. G09G 3/36

(52) U.S. Cl. 345/98

(57) ABSTRACT

A display and a display panel thereof are provided. A driving circuit is formed on one side of the display panel to output an auxiliary scan signal to one terminal of the scan line in the display panel. A gate driver is formed on another side of the display panel to output a scan signal to another terminal of the scan line in the display panel, so that the two ends of a scan line in the display panel simultaneously receive the scan signal and the auxiliary scan signal. Thereby, not only the display quality of the display is improved and the difficult of repairing the display panel is reduced, but also the production yield rate of the display can be effectively increased. Besides, if the gate driver is not used in the display panel, the driving circuit can be simultaneously formed on both sides of the display panel.

### CROSS-REFERENCE TO RELATED APPLICATION

This application claims the priority benefit of Taiwan application serial no. 95130614, filed Aug. 21, 2006. All disclosure of the Taiwan application is incorporated herein by reference.

### BACKGROUND OF THE INVENTION

1. Field of the Invention

The present invention relates to a display and a display panel thereof, and more particularly, to a liquid crystal display panel with a driving circuit formed on two sides and a liquid crystal display having such a display panel.

2. Description of Related Art

With the popularization of liquid crystal displays, one of the methods of lowering the cost of producing liquid crystal displays is to directly fabricate the driving circuit on the display panel.

FIG. 1 is a block diagram showing the conventional technique of forming a driving circuit on a display panel. As shown in FIG. 1, the driving circuit 100 includes a clock generator 101 and a plurality of driving devices 103. It is obvious from the coupling relationships of the driving circuit that the output terminal OUT of each driving device 103 is coupled to the input terminal IN of the next driving device 103 and the corresponding scan line (not shown) inside the display panel. Furthermore, each driving device 103 has two clock-receiving terminals CR1, CR2 for receiving two of the three phase-shifted clock signals C1˜C3 provided by the clock generator 101. Then, each driving device 103 is transferred the two phase-shifted clock signals so that the state of the scan signal from the output terminal OUT is determined.

However, in the conventional driving circuit 100, the output terminal OUT of a defective driving device 103 is incapable of outputting a scan signal to the input terminal IN of the next driving device 103 and its corresponding scan line inside the display panel. Thus, although the conventional driving circuit 100 is able to lower the production cost of a liquid crystal display, but the follow hard at heel problems including the display quality of the liquid crystal display is demoted and the difficult of repairing the display panel is increased. Moreover, the production yield rate of the liquid crystal display maybe decreased.

In addition, the conventional driving circuit 100 on one side of the display panel transmits a scan signal to the other through a corresponding scan line inside the display panel. Therefore, as the size of a manufactured display panel increases, the degree of attenuation of the scan signal through the scan line also increases. Hence, the amount of flicker phenomenon in the liquid crystal display is more likely to get worse.

### SUMMARY OF THE INVENTION

Accordingly, at least one objective of the present invention is to provide a display panel. By forming a driving circuit on one side of the display panel to output an auxiliary scan signal and receiving a scan signal from a gate driver on the other side of the display panel, the two ends of a scan line inside the display panel is able to simultaneously receive the scan signal and the auxiliary scan signal. Hence, not only the display quality of the liquid crystal display is improved and the difficult of repairing the display panel is reduced, but also the production yield rate of the liquid crystal display can be effectively increased.

At least another objective of the present invention is to provide a display panel. By forming driver circuits on both sides of the display panel to simultaneously output an auxiliary scan signal, all the advantages in the aforementioned display panel of the present invention are also acquired.

At least another objective of the present invention is to provide a display. By using aforementioned display panel of the present invention in the display, not only to acquire the advantages of the foregoing display panel in the present invention, but also to reduce the flicker phenomenon in the display panel and lower the production cost.

To achieve these and other advantages and in accordance with the purpose of the invention, as embodied and broadly described herein, the invention provides a display panel comprising a plurality of scan lines and a driving circuit. One terminal of each scan lines is used for receiving a scan signal. The driving circuit includes a clock generator and a plurality of driving devices. The clock generator provides at least two phase-shifted signals, and each of the driving devices is coupled to the corresponding scan line and the clock generator. Furthermore, each of the driving devices is connected to each other in series. According to the two phase-shifted clock signals provided by the clock generator, each of the driving devices outputs an auxiliary scan signal to the other terminal of the corresponding scan line.

From another aspect, the present invention provides a display panel comprising a plurality of scan lines and a driving circuit. The driving circuit includes a clock generator and a plurality of driving devices. The clock generator provides at least two phase-shifted signals, and each of the driving devices is coupled to the corresponding scan line and the clock generator. Furthermore, each of the driving devices is connected to each other in serial. According to the two phase-shifted clock signals provided by the clock generator, each of the driving devices outputs an auxiliary scan signal to one of the two terminals of the corresponding scan line.

From yet another aspect, the present invention provides a display comprising a gate driver and a display panel. The gate driver is used for outputting a plurality of scan signals. The display panel includes a plurality of scan lines and a driving circuit. One terminal of each scan lines is used for receiving the corresponding scan signal from the gate driver. The driving circuit includes a clock generator and a plurality of driving devices. The clock generator provides at least two phase-shifted signals, and each of the driving devices is coupled to the corresponding scan line and the clock generator. Furthermore, each of the driving devices is connected to each other in series. According to the two phase-shifted clock signals provided by the clock generator, each of the driving devices outputs an auxiliary scan signal to the other terminal of the corresponding scan line.

From still another aspect, the present invention provides a display characterized by a display panel. The display panel includes a plurality of scan lines and a driving circuit. The driving circuit includes a clock generator and a plurality of driving devices. The clock generator provides at least two phase-shifted signals, and each of the driving devices is coupled to the corresponding scan line and the clock generator. Furthermore, each of the driving devices is connected to each other in series. According to the two phase-shifted clock signals provided by the clock generator, each of the driving devices outputs an auxiliary scan signal to one of the two terminals of the corresponding scan line.

The display panel of the present invention can be used in a display (for example, a liquid crystal display). By forming a driving circuit on one side of the display panel to output an auxiliary signal to one terminal of the scan line in the display and forming a gate driver on another side of the display panel to output a scan signal to the other terminal of the scan line in the display panel, so that the two terminals of a scan line inside the display panel simultaneously receive the auxiliary scan signal and the scan signal. Hence, not only the display quality of the liquid crystal display is improved and the difficult of repairing the display panel is reduced, but also the production yield rate of the liquid crystal display can be effectively increased. In addition, even when the gate driver is not used, the driving circuit can be simultaneously formed on both sides of the display panel. Thereby, to acquire the aforementioned advantages, and reduce flicker phenomenon in the display and lower the production cost.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the conventional technique of forming a driving circuit on a display panel.

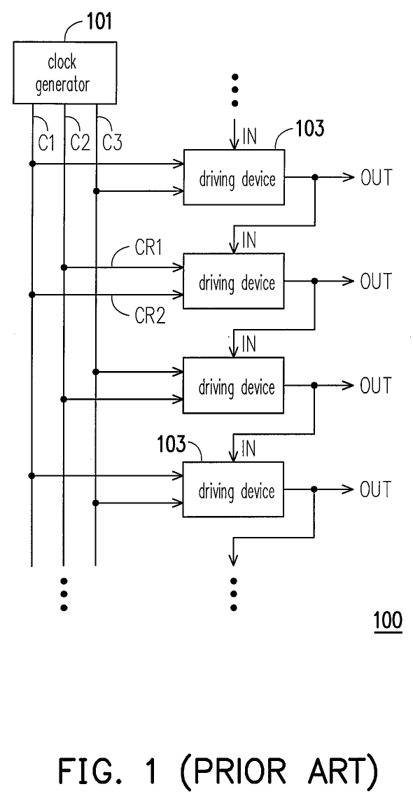

FIG. 2 is a block diagram of a display according to one embodiment of the present invention.

FIG. 3 is a block diagram of a display according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

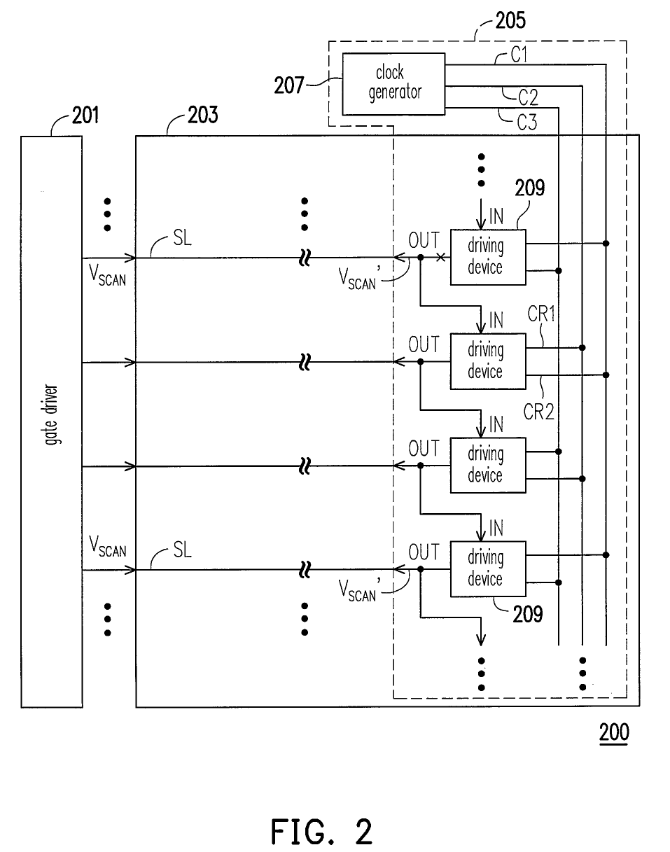

FIG. 2 is a block diagram of a display according to one embodiment of the present invention. The display 200 (for example, a liquid crystal display) includes a gate driver 201 and a display panel 203. The gate driver 201 is used for outputting a scan signal V_{SCAN} in sequentially, and the display panel 203 has a plurality of scan lines SL and a driving circuit 205 therein. In the present embodiment, one terminal of each scan line SL is used for receiving the scan signal V_{SCAN} from the gate driver 201.

The driving circuit 205 includes a clock generator 207 and a plurality of driving devices 209. The clock generator 207 provides three phase-shifted clock signals C1˜C3. Each of driving devices 209 includes an input terminal IN, an output terminal OUT, a first clock-receiving terminal CR1 and a second clock-receiving terminal CR2. Each of the driving devices 209 is connected to each other in series. In other words, the input terminal IN of each driving devices 209 is coupled to the output terminal OUT of the previous driving device 209, and the output terminal OUT of each driving device 209 is coupled to the corresponding scan line SL. Furthermore, the first and the second clock-receiving terminals CR1, CR2 of each driving device 209 are independently used for receiving two of the three phase-shifted clock signals C1˜C3 provided by the clock generator 207.

In the present embodiment, the clock generator 207 provides two of the three phase-shifted signals C1˜C3 to the first and the second clock-receiving terminals CR1, CR2 of each driving device 209. Then, according to the two phase-shifted clock signals, each driving device 209 outputs an auxiliary scan signal V_{SCAN}′ to the other terminal of the corresponding scan line SL. It should be noted that, in another embodiment of the present invention, the clock generator 207 may provide only two phase-shifted clock signals C1, C2 to the first and second clock-receiving terminals CR1 and CR2 of each driving device 209 to achieve the same function.

In the foregoing description of the present embodiment with reference to FIG. 2, one terminal of each scan line SL inside the display panel 203 is used for receiving the scan signal V_{SCAN} from the gate driver 201 and the other terminal of the scan line SL is used for receiving the auxiliary scan signal V_{SCAN}′ from the driving circuit 205. Furthermore, the input terminal IN of each driving device 209 is coupled to the corresponding scan line SL of the previous driving device 209. Therefore, when the display 200 is in normal operation, the two terminals of each scan lines SL inside the display panel 203 will simultaneously receive two scan signals, namely, the scan signal V_{SCAN} and the auxiliary scan signal V_{SCAN}′. Consequently, in a large-size display panel, the problem of the signal attenuation along the scan lines as a result of the conventional single-sided application of the scan signals is resolved. Thus, the flicker phenomenon in the display 200 is effectively reduced.

In addition, when one particular driving device 209 is defective, just only the output terminal OUT of the defective driving device 209 (marked with an ‘X’ in FIG. 2) has to be cut. The scan signal V_{SCAN} from the other terminal of the corresponding scan line SL will provide a signal to the input terminal IN of the next driving device 209. In this way, the display panel 203 is unaffected by the defective driving device 209 so that the display 200 can operate normally. Hence, not only the difficult of repairing the display panel 203 is reduced, but also the production yield rate of the display 200 can be effectively increased.

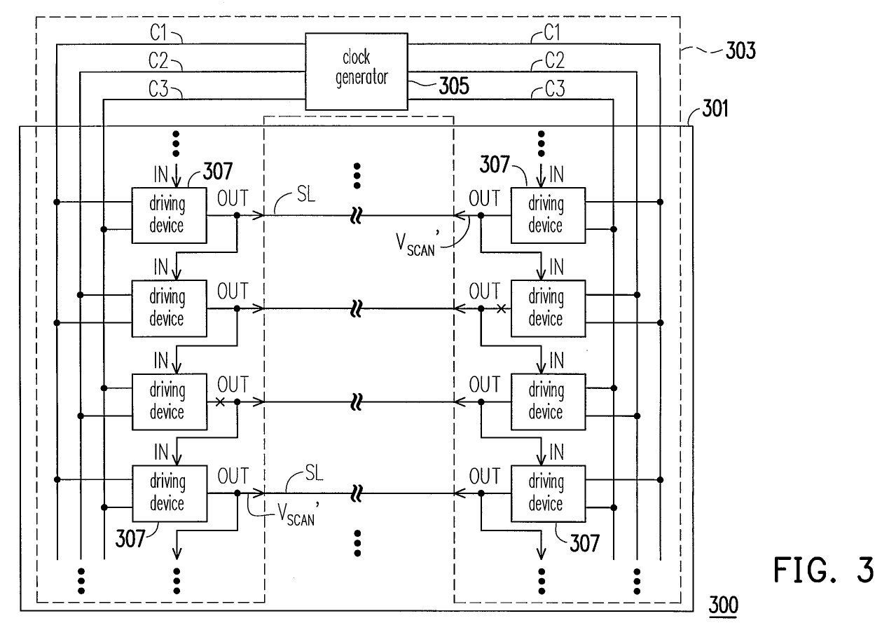

FIG. 3 is a block diagram of a display according to another embodiment of the present invention. One major characteristic of the display 300 in FIG. 3 is the presence of a display panel 301. The display panel 301 includes a plurality of scan lines SL and a driving circuit 303. The driving circuit 303 includes a clock generator 305 and a plurality of driving devices 307.

In the present embodiment, the clock generator 305 provides three phase-shifted clock signals C1˜C3, and each terminal of each of the scan lines SL is independently couple to a driving device 307. Furthermore, each of the driving devices 307 has an input terminal IN, an output terminal OUT, a first clock-receiving terminal CR1 and a second clock-receiving terminal CR2. Each of the driving devices 307 is connected to each other in serial. In other words, the input terminal IN of each driving device 307 is coupled to the output terminal OUT of the previous driving device 307, and the output terminal OUT of each driving device 307 is coupled to the corresponding scan line SL. Furthermore, the first and the second clock-receiving terminal CR1, CR2 of each driving device 307 are independently used for receiving two of the three phase-shifted clock signals C1˜C3 provided by the clock generator 305.

In addition, the clock generator 305 provides two of the three phase-shifted clock signals C1˜C3 to the first and the second clock-receiving terminals CR1, CR2 of each driving devices 307. Then, according to the two phase-shifted clock signals, each driving devices 307 outputs an auxiliary scan signal V_{SCAN}′ to the two terminals of the corresponding scan line SL. It should be noted that, in another embodiment of the present invention, the clock generator 307 may provide only two phase-shifted clock signals C1, C2 to the first and second clock-receiving terminals CR1 and CR2 of each driving device 307 to achieve the same function.

In the foregoing description of the present embodiment with reference to FIG. 3, the two terminals of each scan line SL inside the display panel 301 are used for receiving the auxiliary scan signals V_{SCAN}′ from the driving circuit 303. Furthermore, the input terminal IN of each driving device 307 is coupled to the corresponding scan line SL of the previous driving device 307. Therefore, when the display 300 is in normal operation, the two terminals of each scan line SL inside the display panel 301 will simultaneously receive two auxiliary scan signals V_{SCAN}′. Consequently, in a large-size display panel, the problem of the signal attenuation along the scan lines as a result of the conventional single-sided application of the scan signals is resolved. Thus, flicker in the display 300 is effectively reduced.

In addition, when one particular driving device 307 is defective, just only the output terminal OUT of the defective driving device 307 (marked with an ‘X’ in FIG. 3) has to be cut. The scan signal V_{SCAN}′ from the other terminal of the corresponding scan line SL will provide a signal to the input terminal IN of the next driving device 307. In this way, the display panel 301 is unaffected by the defective driving device 307 so that the display 300 can operate normally. Hence, the difficult of repairing the display panel 203 is similarly reduced. Furthermore, since the probability of the driving devices 307 at both terminals of each scan lines SL inside the display panel 301 being defective is the lowest. Therefore, the production yield rate of the display 300 can be effectively increased.

Because the display 300 disclosed in FIG. 3 does not use a gate driver as in the display 200, so that, the display 300 will have a lower production cost compared to the display 200.

In summary, the display and the display panel thereof in the present invention has at least the following advantages:

1. Because a driving circuit is formed on one side of the display panel to output the auxiliary scan signal to one, terminal of the scan line in the display panel and the other terminal of the scan line in the other side of the display panel receives the scan signal from the gate driver of the existing structure, the two terminals of the scan lines inside the display panel can simultaneously receive the scan signal and the auxiliary scan signal. Hence, not only the display quality of the liquid crystal display is improved and the difficult of repairing the display panel is reduced, but also the production yield rate of the liquid crystal display can be effectively increased.

2. Even when the gate driver of the existing structure is not used, the driving circuit may still be simultaneously formed on both sides of the display panel, not only to acquire the aforementioned advantages, but also to reduce flicker phenomenon in the display and lower the production cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display panel, comprising:
a plurality of scan lines, wherein one terminal of each of the scan lines is used for receiving a scan signal; and
a driving circuit, comprising:
a clock generator for providing at least two phase-shifted clock signals; and
a plurality of driving devices coupled to corresponding scan lines and the clock generator, the driving devices connected to each other in series, and each of the driving device outputting an auxiliary scan signal to the other terminal of each of the corresponding scan lines according to the at least two phase-shifted clock signals provided by the clock generator.

2. The display panel of claim 1, wherein each of the driving devices has an input terminal, an output terminal, a first clock-receiving terminal and a second clock-receiving terminal, wherein the input terminal of each of the driving devices is coupled to the output terminal of the driving device that corresponding to the preceding scan line, the output terminal of each of the driving devices is coupled to the corresponding scan line, and the first clock-receiving terminal and the second clock-receiving terminal of each of the driving devices are independently used to receive the at least two phase-shifted clock signals provided by the clock generator.

3. A display panel, comprising:
a plurality of scan lines; and
a driving circuit, comprising:
a clock generator for providing at least two phase-shifted clock signals; and
a plurality of driving devices coupled to the two ends of their corresponding scan lines and the clock generator, the driving devices connected to each other in serial, and outputting an auxiliary scan signal to both terminals of each of their corresponding scan lines according to the at least two phase-shifted clock signals provided by the clock generator.

4. The display panel of claim 3, wherein each of the driving devices has an input terminal, an output terminal, a first clock-receiving terminal and a second clock-receiving terminal, wherein the input terminal of each of the driving devices is coupled to the output terminal of the driving device that corresponding to the preceding scan line, the output terminal of each of the driving devices is coupled to the corresponding scan line, and the first clock-receiving terminal and the second clock-receiving terminal of each of the driving devices are independently used to receive the at least two phase-shifted clock signals provided by the clock generator.

5. A display, comprising:
a gate driver for outputting a plurality of scan signals; and
a display panel, comprising:
a plurality of scan lines, wherein one terminal of each of the scan lines is used for receiving one of the scan signals; and
a driving circuit, comprising:
a clock generator for providing at least two phase-shifted clock signals; and
a plurality of driving devices coupled to corresponding scan lines and the clock generator, the driving devices connected to each other in series, and each driving device outputting an auxiliary scan signal to the other terminal of each of the corresponding scan lines according to the at least two phase-shifted clock signals provided by the clock generator.

6. The display of claim 5, wherein each of the driving devices has an input terminal, an output terminal, a first clock-receiving terminal and a second clock-receiving terminal, wherein the input terminal of each of the driving devices is coupled to the output terminal of the driving device that corresponding to the preceding scan line, the output terminal of each of the driving devices is coupled to the corresponding scan line, and the first clock-receiving terminal and the second clock-receiving terminal of each of the driving devices are independently used to receive the at least two phase-shifted clock signals provided by the clock generator.

7. The display of claim 5, wherein the display panel comprises a liquid crystal display panel.

8. A display, characterized by:
a display panel, comprising:
a plurality of scan lines; and
a driving circuit, comprising:
a clock generator for providing at least two phase-shifted clock signals; and
a plurality of driving devices coupled to the two ends of their corresponding scan lines and the clock generator, the driving devices connected to each other in serial, and outputted an auxiliary scan signal to both terminals of each of their corresponding scan lines according to the at least two phase-shifted clock signals provided by the clock generator.

9. The display of claim 8, wherein each of the driving devices has an input terminal, an output terminal, a first clock-receiving terminal and a second clock-receiving terminal, wherein the input terminal of each of the driving devices is coupled to the output terminal of the driving device that corresponding to the preceding scan line, the output terminal of each of the driving devices is coupled to the corresponding scan line, and the first clock-receiving terminal and the second clock-receiving terminal of each of the driving devices are independently used to receive the at least two phase-shifted clock signals provided by the clock generator.

10. The display of claim 8, wherein the display panel comprises a liquid crystal display panel.
